(19) United States
(12) Patent Application Publication
(10) Pub. No.: US 2014/0353509 A1
(43) Pub. Date: Dec. 4, 2014

(54) RADIOGRAPHIC IMAGE DETECTION DEVICE

(71) Applicant: FUJIFILM Corporation, Tokyo (JP)

(72) Inventor: Haruyasu NAKATSUGAWA, Ashigarakami-gun (JP)

(21) Appl. No.: 14/460,834

(22) Filed: Aug. 15, 2014

Related U.S. Application Data
(63) Continuation of application No. PCT/JP2013/054973, filed on Feb. 26, 2013.

(30) Foreign Application Priority Data
Mar. 13, 2012 (JP) 2012-055534
Feb. 12, 2013 (JP) 2013-024091

(51) Int. Cl. G01T 1/20; G01N 23/04

(52) U.S. Cl. CPC G01T 1/2018; G01N 23/04
USPC 250/361 R

(57) ABSTRACT

Disclosed is a radiographic image detection device which prevents electrostatic charging without causing absorption loss of radiation. The radiographic image detection device has a solid-state detector 20, a wavelength conversion layer 21, and a support 22 arranged in this order from the incidence side of radiation. The wavelength conversion layer 21 converts radiation transmitted through the solid-state detector 20 to visible light. The solid-state detector 20 detects visible light to generate image data. The support 22 has a light reflection layer 22b and an antistatic resin film 22a. The antistatic resin film 22a prevents the support 22 from being electrostatically charged by friction or the like.

### CROSS-REFERENCE TO RELATED APPLICATIONS

This application is a Continuation of PCT International Application No. PCT/JP2013/054973 filed on Feb. 26, 2013, which claims priority under 35 U.S.C §119(a) to Japanese Patent Application No. 2012-055534 filed on Mar. 13, 2012 and Japanese Patent Application No. 2013-024091 filed on Feb. 12, 2013. Each of the above applications is hereby expressly incorporated by reference, in its entirety, into the present application.

### BACKGROUND OF THE INVENTION

1. Field of the Invention

The present invention relates to a radiographic image detection device which converts radiation to light by a wavelength conversion layer (phosphor layer) to detect a radiographic image.

2. Description of the Related Art

In the field of medicine or the like, various radiographic image detection devices which irradiate radiation, such as an X-ray, onto a subject and detect the radiation transmitted through the subject to detect a radiographic image of the subject have come into practical use. As the radiographic image detection device, an electrical reading system radiographic image detection device which generates an electric charge according to the incidence of radiation and converts the electric charge to a voltage to generate image data representing a radiographic image has come into wide use.

The electrical reading system radiographic image detection device includes a direct conversion system radiographic image detection device which directly converts radiation to an electric charge by a semiconductor layer, such as selenium, and an indirect conversion system radiographic image detection device which converts radiation to light by a wavelength conversion layer once and converts light to an electric charge by a solid-state detector having a photodiode or the like.

The wavelength conversion layer contains a phosphor which converts radiation to visible light. The phosphor is a particle (hereinafter, referred to as a phosphor particle), such as GOS (Gd₂O₂S:Tb), or columnar crystal, such as Cs1:T1. The wavelength conversion layer having a particle structure is easy to manufacture and inexpensive compared to the wavelength conversion layer having a columnar crystal structure, and is thus widely used. The wavelength conversion layer having a particle structure is formed by dispersing phosphor particles in a binder, such as resin.

Of the wavelength conversion layers, the wavelength conversion layer having a particle structure is generally formed on a substrate formed of a resin material. This substrate is likely to be electrostatically charged, and electrostatic charging may cause noise to be superimposed on image data, resulting in image unevenness. Image unevenness may degrade diagnosis precision in medical diagnosis, and is thus a major problem. In particular, in an electronic cassette in which a radiographic image detection device is portable, the substrate comes into contact with other members to cause friction due to vibration during transportation or vibration caused by a load or the like from a subject (patient), and thus electrostatic charging is more likely to occur.

In regard to this, in the radiographic image detection device described in JP2009-128023A, a metal thin film is formed in a moisture-proof body formed of a resin material covering the wavelength conversion layer, and the metal thin film is at a given potential (for example, a ground potential).

### SUMMARY OF THE INVENTION

However, in the radiographic image detection device described in JP2009-128023A, since radiation is incident on the wavelength conversion layer through the metal thin film, absorption loss of radiation may be generated due to the metal thin film. When the thickness of the metal thin film has unevenness, there is a problem in that unevenness is superimposed on a radiographic image of the subject. The metal thin film functions as an electromagnetic shield for suppressing the entrance of electromagnetic noise from the outside, and strictly, does not prevent electrostatic charging.

An object of the invention is to provide a radiographic image detection device capable of preventing electrostatic charging without causing absorption loss of radiation.

In order to solve the above-described problem, according to an aspect of the invention, there is provided a radiographic image detection device including a wavelength conversion layer which converts radiation to light, a support which supports the wavelength conversion layer, and a solid-state detector which detects light to generate image data. The solid-state detector, the wavelength conversion layer, and the support are arranged in an order of the solid-state detector, the wavelength conversion layer, and the support from the incidence side of radiation during imaging, and the support has an antistatic property.

It is preferable that the support has an antistatic resin film. It is preferable that the surface specific resistance value of the antistatic resin film is equal to or greater than 10⁶Ω and equal to or smaller than 10⁹Ω. It is preferable that the support has a resin film and an antistatic layer formed on the side of the resin film opposite to the wavelength conversion layer. It is preferable that the antistatic layer is formed of a conductive material containing atoms having an atomic number of 20 to 31. In particular, it is preferable that the antistatic layer is formed of a conductive material containing one or two or more of atoms having an atomic number of 24, 26, 28, 29, and 30.

It is preferable that the support has a resin film, a first antistatic layer formed on the side of the resin film opposite to the wavelength conversion layer, and a second antistatic layer formed on the side of the resin film facing the wavelength conversion layer.

It is preferable that the support has a resin film and first and second antistatic layers formed on the side of the resin film opposite to the wavelength conversion layer, and the first and second antistatic layers are arranged in an order of the second antistatic layer and the first antistatic layer from the resin film side.

It is preferable that the first antistatic layer is formed of a conductive material containing atoms having an atomic number greater than 31, and the second antistatic layer is formed of a conductive material containing atoms having an atomic number of 20 to 31. In particular, it is preferable that the second antistatic layer is formed of a conductive material containing one or two or more of atoms having an atomic number of 24, 26, 28, 29, and 30.

It is preferable that the composite elasticity of the wavelength conversion layer and the support is lower than the elasticity of the solid-state detector. It is preferable that each conductive material is in a powdered state and dispersed in a binder.

The radiographic image detection device may further include a third antistatic layer on the side of the solid-state detector opposite to the wavelength conversion layer. In this case, it is preferable that the first antistatic layer, the second antistatic layer, and the third antistatic layer are connected to a ground potential.

It is preferable that radiographic image detection device further includes an edge pasting member having an antistatic property to cover the lateral surface of the peripheral edge of the wavelength conversion layer. In this case, it is preferable that the first antistatic layer and the second antistatic layer are connected to the ground potential through the edge pasting member.

It is preferable that the wavelength conversion layer is formed by dispersing phosphor particles in a binder. It is preferable that the phosphor particles are formed of A₂O₂S:X, A is one of Y, La, Gd, and Lu, and X is one of Eu, Tb, and Pr.

It is preferable that the support has a light reflection layer which reflects light generated by the wavelength conversion layer, and the light reflection layer is bonded to the wavelength conversion layer.

According to the radiographic image detection device of the invention, since the solid-state detector, the wavelength conversion layer, and the support are arranged in this order from the incidence side of radiation, and the support has an antistatic property, it is possible to prevent electrostatic charging without causing absorption loss of radiation.

### BRIEF DESCRIPTION OF THE DRAWINGS

FIG. 1 is an explanatory view showing the configuration of a radiographic imaging system.

FIG. 2 is a perspective view of a radiographic image detection device.

FIG. 3 is an explanatory view showing the configuration of a solid-state detector.

FIG. 4 is a sectional view of a radiographic image detection device.

FIG. 5 is a first manufacturing process view of the radiographic image detection device.

FIG. 6 is a second manufacturing process view of the radiographic image detection device.

FIG. 7 is a third manufacturing process view of the radiographic image detection device.

FIG. 8 is a sectional view of a radiographic image detection device of a second embodiment.

FIG. 9 is a graph showing dependence of a backscattered X-ray dose on an atomic number.

FIG. 10 is a sectional view of a radiographic image detection device of a third embodiment.

FIG. 11 is a sectional view of a radiographic image detection device of a fourth embodiment.

FIG. 12 is a sectional view of a first ground potential connection state of the radiographic image detection device of the fourth embodiment.

FIG. 13 is a sectional view of a second ground potential connection state of the radiographic image detection device of the fourth embodiment.

FIG. 14 is a sectional view of a radiographic image detection device of a fifth embodiment.

### DESCRIPTION OF THE PREFERRED EMBODIMENTS

### First Embodiment

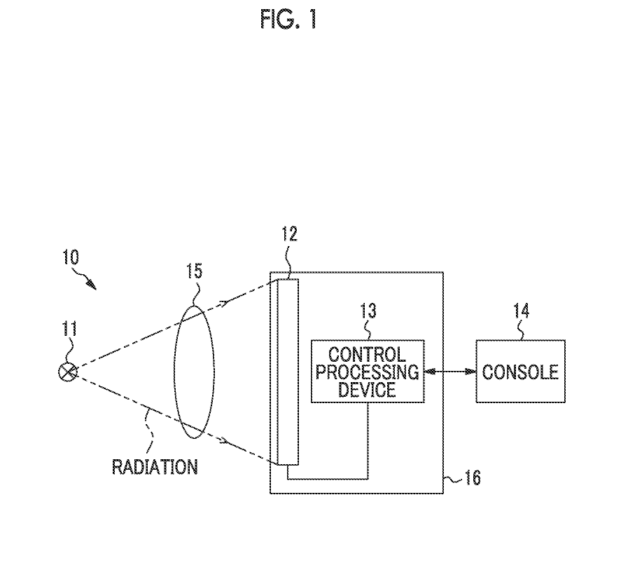

In FIG. 1, a radiographic imaging system 10 includes a radiation source 11, a radiographic image detection device 12, a control processing device 13, and a console 14. The radiation source 11 emits radiation (X-ray) toward a subject 15. The radiographic image detection device 12 detects radiation transmitted through the subject 15, and generates and outputs image data representing a radiographic image of the subject 15 carried in the radiation.

The control processing device 13 drives the radiographic image detection device 12 based on a control signal from the console 14, and carries out predetermined signal processing on image data output from the radiographic image detection device 12. The console 14 has an operating device and a display device (not shown), generates a control signal according to user operation on the operating device, and outputs the control signal to the control processing device 13. The console 14 displays a radiographic image on the display device based on image data subjected to signal processing by the control processing device 13.

The radiographic image detection device 12 and the control processing device 13 are housed in a housing 16, and constitute a so-called electronic cassette. An image memory which stores image data or a battery which performs power supply to the respective units may be housed in the housing 16.

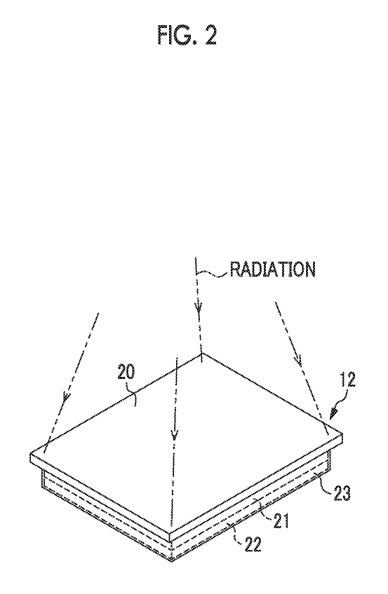

In FIG. 2, the radiographic image detection device 12 has a solid-state detector 20, a wavelength conversion layer 21, a support 22, and an edge pasting member 23. The solid-state detector 20, the wavelength conversion layer 21, and the support 22 are laminated in this order from the radiation source 11 side. Radiation emitted from the radiation source 11 and transmitted through the subject 15 is transmitted through the solid-state detector 20 and is incident on the wavelength conversion layer 21.

The wavelength conversion layer 21 is a phosphor layer (scintillator) which converts radiation incident during imaging to light (visible light) having a longer wavelength. The solid-state detector 20 detects visible light converted by the wavelength conversion layer 21 to generate image data representing a radiographic image. The edge pasting member 23 covers the lateral surfaces of the peripheral edges of the wavelength conversion layer 21 and the support 22.

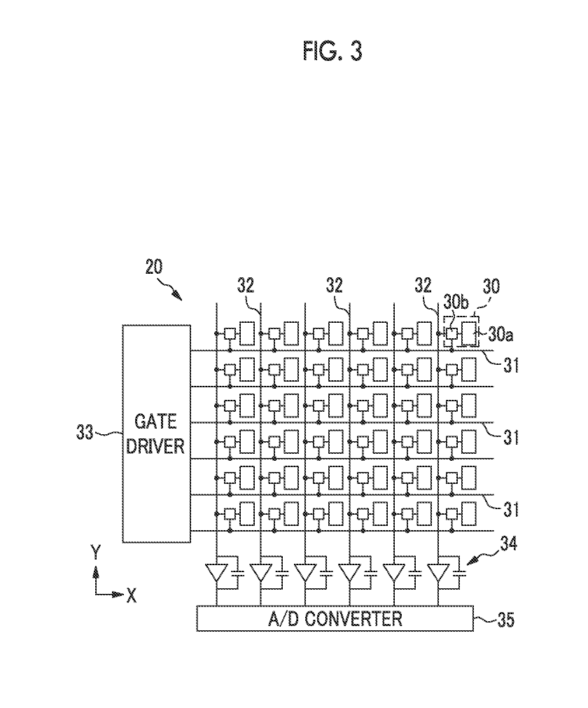

In FIG. 3, the solid-state detector 20 includes pixels 30, scanning lines 31, data lines 32, a gate driver 33, integral amplifiers 34, and an A/D converter 35. The pixels 30 respectively have a photodiode 30a and a TFT switch 30b, and are arranged in a two-dimensional manner in the X-Y directions. Each of the scanning lines 31 is provided for each row of pixels 30 arranged in the X direction, and a scanning signal for driving the TFT switches 30b is applied to the scanning line 31. Each of the data lines 32 is provided for each column of pixels 30 arranged in the Y direction, and a signal charge accumulated in the photodiode 30a and read through the TFT switch 30b flows in the data line 32.

The photodiode 30a receives visible light generated by the wavelength conversion layer 21 and generates and accumulates a signal charge. The TFT switch 30b is provided to correspond to each intersection of the scanning lines 31 and the data lines 32, and is connected to the photodiode 30a.

The gate driver 33 is connected to one end of each scanning line 31, and sequentially applies the scanning signal to the scanning line 31. Each of the integral amplifiers 34 is connected to one end of each data line 32, integrates the signal charge flowing in the data line 32, and outputs a voltage corresponding to the integrated charge. The A/D converter 35 is provided on the output side of each integral amplifier 34, and converts a voltage output from the integral amplifier 34 to a digital signal. A voltage amplifier, a multiplexer, and the like are provided between the integral amplifier 34 and the A/D converter 35, but are not shown in the drawing for simplification. Image data is constituted by the digital signals for all pixels output from the A/D converter 35.

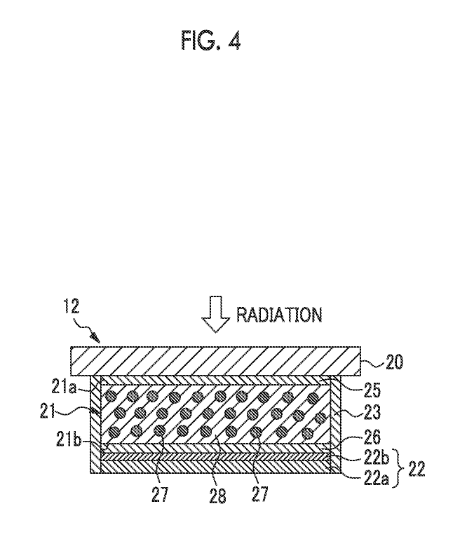

In FIG. 4, the wavelength conversion layer 21 has a first surface 21a bonded to the solid-state detector 20 through an adhesive layer 25, and a second surface 21b bonded to the support 22 through an adhesive layer 26. The adhesive layers 25 and 26 are formed of an acryl-based material. The support 22 is constituted by laminating an antistatic resin film 22a and a light reflection layer 22b, and the light reflection layer 22b is bonded to the wavelength conversion layer 21 through the adhesive layer 26.

The antistatic resin film 22a is a resin film which can uniformize an electric charge without locally charging static electricity, and a resin film in which an antistatic agent is kneaded (antistatic agent-kneaded type), or a resin film having an antistatic effect (sustainable antistatic type). It is preferable that the surface specific resistance value of the antistatic resin film 22a is equal to or greater than 10⁶Ω and equal to or smaller than 10⁹Ω. The measurement of the surface specific resistance is performed by a surface resistance measurement method described in JIS K6911-1995.

In the antistatic agent-kneaded type, for example, a water-soluble antistatic agent (surfactant) and oily plastic are forcibly mixed and dispersed, and the antistatic agent floats to the surface of plastic by a bleeding phenomenon. In the sustainable antistatic type, for example, special metal ion binding resin, a metallocene catalyst polymerized polyethylene, and a polymer are mixed.

The light reflection layer 22b is formed by dispersing a light reflective material, such as alumina particulates, in resin, such as acryl, and reflects light, which is generated by the wavelength conversion layer 21 and propagates toward the support 22, to the solid-state detector 20 side.

The edge pasting member 23 is formed of resin or the like. It is preferable that the thickness of the edge pasting member 23 is equal to or greater than 5 μm and equal to or smaller than 500 μm. The edge pasting member 23 is, for example, a cured film of a silicon-based polymer and polyisocyanate.

As the silicon-based polymer, a polymer in which a component (polymer, prepolymer, or monomer) primarily having a polysiloxane unit and another component (polymer, prepolymer, or monomer) are alternately bonded to a block or a pendant by condensation reaction or polyaddition reaction is used. Examples of the silicon-based polymer include polyurethane having a polysiloxane unit, polyurea having a polysiloxane unit, polyester having a polysiloxane unit, and acrylic resin having a polysiloxane unit.

As polyisocyanate, various polyisocyanate monomers, adducts of polyol, such as TIMP (trimethylolpropane) and (poly)isocyanate, such as TDI (tolylene diisocyanate), polymers, such as polymers of dimers of TDI or trimers of TDI and HMDI (hexamethylene diisocyanate), and compounds, such as isocyanate prepolymer obtained by reaction of polyisocyanate, polyfunctional hydroxyl, an amine compound, or polyisocyanate, and hydroxypolyether or polyester, are used. The mixture ratio of the silicon-based polymer and polyisocyanate is 99:1 to 10:90 (polymer:polyisocyanate) in a weight ratio, preferably, 95:5 to 20:80, and more preferably, 90:10 to 70:30.

The edge pasting member 23 may be formed of a conductive material. For example, conductive particulates, such as SnO₂:Sb or ZnO, or carbon clusters, such as carbon black, fullerene, or carbon nanotube, are mixed in a polymer. In this case, it is preferable that the surface specific resistance value of the edge pasting member 23 is equal to or smaller than 10⁸Ω.

The wavelength conversion layer 21 is formed by dispersing phosphor particles 27, such as GOS (Gd₂O₂S:Tb), in a binder 28, such as resin. Although the phosphor particles 27 are shown in a spherical shape, actually, each phosphor particle 27 has a distorted polygonal shape.

As the phosphor particles 27, particles expressed by A₂O₂S:X (however, A is one of Y. La, Gd, and Lu, and X is one of Eu, Tb, and Pr) are used. As the phosphor particles 27, particles in which Ce or Sm as a coactivator is contained in A₂O₂S:X may be used, and mix crystal-based phosphor may be used.

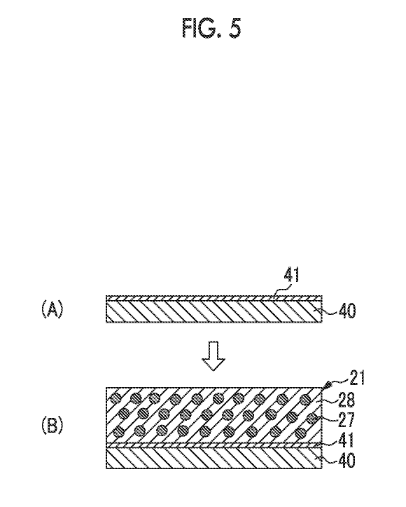

Next, a method of manufacturing the radiographic image detection device 12 will be described referring to FIG. 5. First, in FIG. 5(A), a silicon-based release agent is coated on the surface of a temporary support 40 formed of resin, such as polyethylene telephthalate (PET), thereby forming a release agent layer 41.

Next, in FIG. 5(B), a phosphor coating liquid in which the phosphor particles 27 are dispersed in the solution (binder solution) of the binder 28 is coated on the release agent layer 41 using a doctor blade or the like and dried, whereby the wavelength conversion layer 21 is formed as a phosphor sheet.

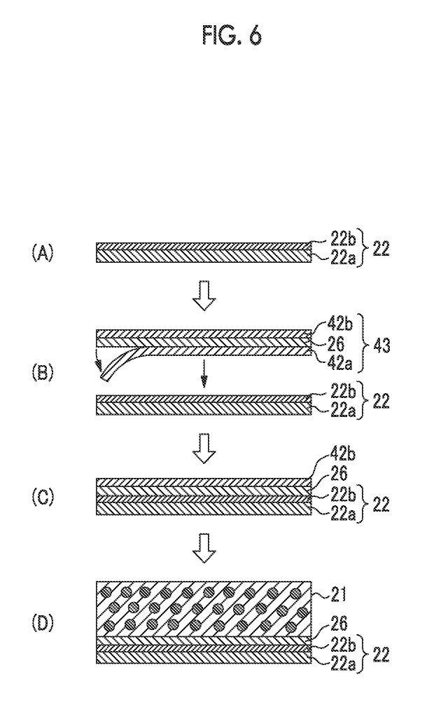

Subsequently, in FIG. 6(A), a coating liquid in which a light reflective material is dispersed is coated on the surface of the antistatic resin film 22a using a doctor blade or the like and dried, thereby forming the light reflection layer 22b. Thus, the above-described support 22 is formed.

In FIG. 6(B), a first adhesive sheet 43 in which a first release film 42a, an adhesive layer 26, and a second release film 42b are laminated in this order is formed, and the first release film 42a is released from the first adhesive sheet 43, whereby as shown in FIG. 6(C), the adhesive layer 26 is bonded to the light reflection layer 22b of the support 22. The adhesive layer 26 is formed of an acryl-based adhesive, and the first and second release films 42a and 42b are formed by PET liners.

Subsequently, the wavelength conversion layer 21 produced in the process of FIG. 5(B) is released from the temporary support 40. In FIG. 6(D), the second release film 42b is released, and the wavelength conversion layer 21 is bonded to the surface of the adhesive layer 26. With this, the wavelength conversion layer 21 is bonded to the support 22 through the adhesive layer 26.

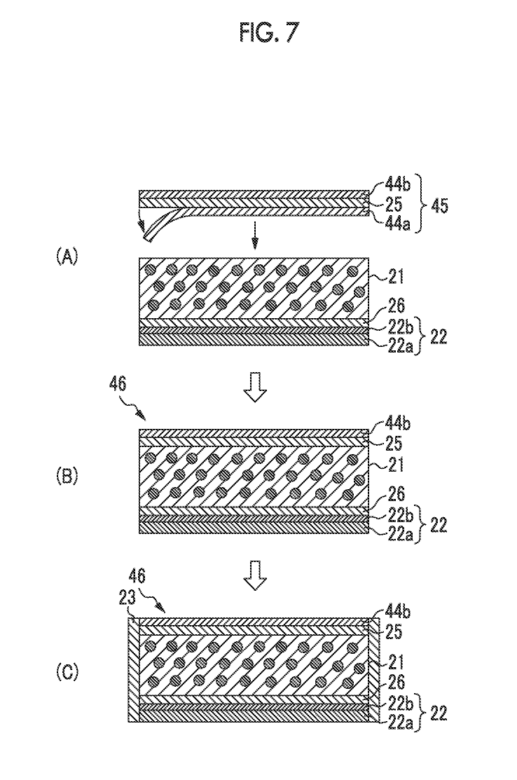

In FIG. 7(A), the second adhesive sheet 45 in which a first release film 44a, an adhesive layer 25, and a second release film 44b are laminated in this order is formed, and the first release film 44a is released from the second adhesive sheet 45, whereby as shown in FIG. 7(B), the adhesive layer 25 is bonded to the wavelength conversion layer 21.

A radiation conversion sheet 46 produced by the above-described process is cut to a prescribed size, and as shown in FIG. 7(C), the edge pasting member 23 is covered using a dispenser on the lateral surface of the peripheral edge of the radiation conversion sheet 46 after cutting.

Thereafter, the second release film 44b is released, and the wavelength conversion layer 21 is bonded to the surface of the solid-state detector 20 separately manufactured by a semiconductor process through the adhesive layer 25. When releasing the second release film 44b, contaminants on the surface of the adhesive layer 25 is removed by an ionizer, and the radiation conversion sheet 46 and the solid-state detector 20 are attached together through the adhesive layer 25 by an attachment machine, and are pressed from the rear surface of the solid-state detector 20 by a roller, whereby the solid-state detector 20 is bonded to the wavelength conversion layer 21. With the above-described process, the radiographic image detection device 12 is completed

Next, the action of the radiographic imaging system 10 will be described. First, radiation is emitted from the radiation source 11 toward the subject 15. Radiation which is transmitted through the subject 15 and has the radiographic image of subject 15 carried therein is incident from the solid-state detector 20 side on the radiographic image detection device 12. Radiation incident on the radiographic image detection device 12 is transmitted through the solid-state detector 20 and is incident on the wavelength conversion layer 21 from the first surface 21a. In the wavelength conversion layer 21, incident radiation is converted to visible light.

Visible light converted by the wavelength conversion layer 21 is incident on the solid-state detector 20. Of visible light converted by the wavelength conversion layer 21, light propagating toward the support 22 is reflected to the solid-state detector 20 side by the light reflection layer 22b. In the solid-state detector 20, photoelectric conversion is performed, and a signal charge generated by photoelectric conversion is read to the pixel 30. The solid-state detector 20 converts each signal charge for one screen to image data and outputs image data.

Image data output from the solid-state detector 20 is input to the control processing device 13, is subjected to signal processing in the control processing device 13, and is then input to the console 14. In the console 14, image display is performed based on input image data.

In this embodiment, since the surface specific resistance value of the antistatic resin film 22a is low, static electricity generated when the support 22 comes into contact with another member moves within the antistatic resin film 22a and an electric charge is uniformized, thereby preventing local electrostatic charging within the support 22. Since the antistatic resin film 22a is provided in the support 22, instead of the solid-state detector 20 side of the wavelength conversion layer 21, radiation does not pass therethrough, and absorption loss of radiation is not generated. For this reason, in the radiographic imaging system 10, satisfactory image display with less image unevenness is performed.

In the above-described embodiment, although the edge pasting member 23 is formed of resin or a conductive material, similarly to the antistatic resin film 22a, the edge pasting member 23 may be formed of a material having an antistatic property. With this, an antistatic performance of preventing local electrostatic charging is improved.

### Second Embodiment

In the first embodiment, although the antistatic agent kneaded type or sustainable antistatic type antistatic resin film 22a has been used, an antistatic resin film in which a resin film with no antistatic property and an antistatic layer are laminated may be used.

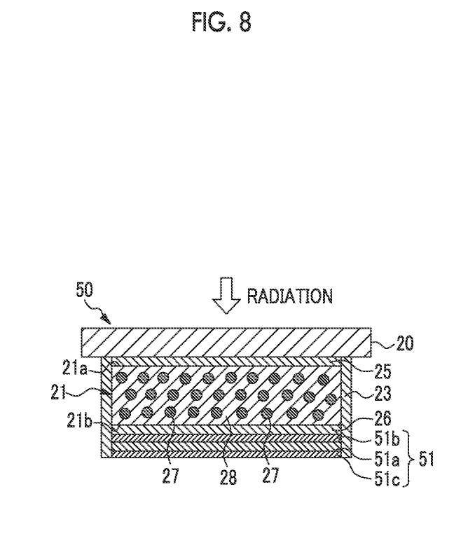

As a second embodiment, a radiographic image detection device 50 shown in FIG. 8 is used. The wavelength conversion layer 21 is supported by a support 51 through the adhesive layer 26. The configuration other than the support 51 is the same as in the first embodiment.

The support 51 is constituted by laminating a resin film 51a, a light reflection layer 51b, and an antistatic layer 51c. The resin film 51a is formed of resin, such as PET having no antistatic property. The light reflection layer 51b is bonded to the side of the resin film 51a facing the wavelength conversion layer 21, and has the same configuration as the light reflection layer 22b of the first embodiment. The antistatic layer 51c is a layer which is formed by coating or depositing an antistatic material or a conductive material on the surface of the resin film 51a opposite to the wavelength conversion layer 21. The surface specific resistance value of the antistatic layer 51c is equal to or greater than 10⁶Ω and equal to or smaller than 10⁹Ω.

As the material of the antistatic layer 51c, a conductive material primarily containing atoms having an atomic number of 20 to 31 is preferably used in terms of radiation backscattering prevention, and for example, copper (Cu) is used. Backscattering refers to a phenomenon in which radiation which is incident on the wavelength conversion layer 21 from the solid-state detector 20 side and cannot be converted by the wavelength conversion layer 21 is incident on the support 51, and is scattered to the side opposite to the incidence side of radiation in the support 51 and returns to the wavelength conversion layer 21. Light emission occurs again with radiation which returns to the wavelength conversion layer 21 by backscattering, causing image blurring. The conductive material primarily containing atoms having an atomic number of 20 to 31 refers to a material in which the weight of a material containing one atom having atomic number of 20 to 31 exceeds 50% and is equal to or smaller than 100% with respect to the weight of the antistatic material 51c.

In the related art, as the material for backscattering prevention, a material primarily containing atoms having a large atomic number, such as lead (Pb) having an atomic number of 82 or tungsten (W) having an atomic number of 74, is used. However, since atoms having a large atomic number have high radiation absorbencyy and while radiation scattering is small, the absorption energy spectrum has a K edge (in case of Pb, 88 keV, and in case of W, 69.5 keV) in a radiation generation energy band (40 to 140 keVp) to be usually used in the radiation source 11, these atoms absorb radiation from the radiation source 11 and generate characteristic X-rays. The characteristic X-rays are directed toward the wavelength conversion layer, and substantially become backscattered rays. In contrast, in case of atoms having an atomic number of 20 to 31, since a K edge is outside the radiation generation energy band (the K edge of Cu is 8.98 keV), characteristic X-rays are rarely generated compared to the atoms having a large atomic number, such as Pb, and the amount of backscattered rays to be generated is small.

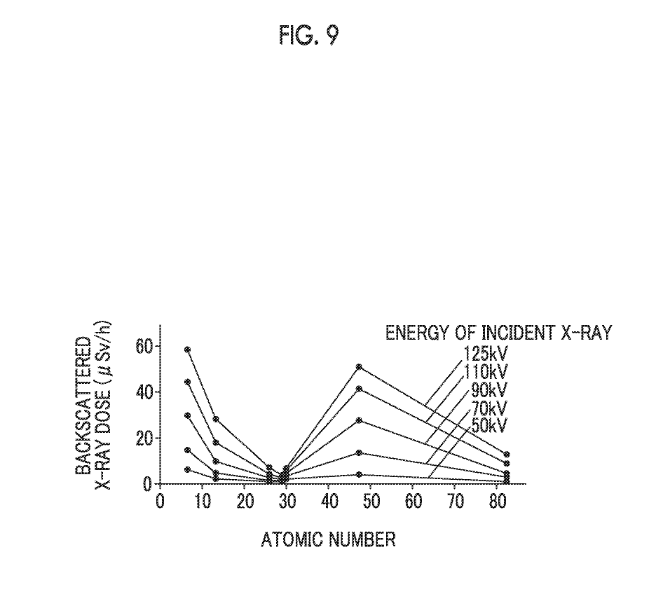

FIG. 9 is a graph showing dependency of a backscattered X-ray dose on an atomic number experimentally obtained by the inventors. From experimental data, it is understood that Cu having an atomic number of 29 has a smallest backscattered X-ray dose and is most suitable as an atom for backscattering prevention.

The material of the antistatic layer 51c is not limited to a material primarily containing one atom having an atomic number of 20 to 31, and may be a material primarily containing two or more atoms having an atomic number of 20 to 31. In particular, it is preferable that the material of the antistatic layer 51c primarily contains one or two or more atoms having an atomic number of 24, 26, 28, 29, and 30. For example, stainless steel primarily containing iron (Fe: atomic number 26) and chromium (Cr: atomic number 24), or iron (Fe: atomic number 26), chromium (Cr: atomic number 24), and nickel (Ni: atomic number 28), brass primarily containing copper (Cu: atomic number 29) and zinc (Zn: atomic number 30), or the like may be used. The material of the antistatic layer 51c primarily containing two or more atoms having an atomic number of 20 to 31 refers to a material in which the weight of a material containing two or more atoms having an atomic number of 20 to 31 exceeds 50% and is equal to or smaller than 100% with respect to the weight of the antistatic material 51c.

In this way, as the material of the antistatic layer 51c, if a material primarily containing atoms having an atomic number of 20 to 31 is used, a backscattering prevention action is obtained in addition to an antistatic action, and thus a satisfactory image with less noise is obtained. The antistatic layer 51c has an action to shield (absorb) backscattered rays from the control processing device 13 or the like arranged on the rear side (the side opposite to the radiation incidence side) of the radiographic image detection device 50. Furthermore, since atoms having an atomic number of 20 to 31 have excellent thermal conductivity, the antistatic layer 51c has high heat dissipation and has an action to shield heat emitted from the control processing device 13 or the like.

When the antistatic layer 51c is formed of a conductive material, the elasticity (Young's modulus) of the support 51 increases, whereby in a state where the wavelength conversion layer 21 is bonded to the support 51, the composite elasticity of the wavelength conversion layer 21 and the support 51 increases. If the composite elasticity is high, since adhesion when bonding the wavelength conversion layer 21 to the solid-state detector 20 is degraded, it is preferable that the composite elasticity of the wavelength conversion layer 21 and the support 51 is lower than the elasticity of the solid-state detector 20. The composite elasticity can be obtained based on a compound rule of Young's modulus

In order to decrease the composite elasticity of the support 51, powder of a conductive material (preferably, atoms having an atomic number of 20 to 31) may be dispersed in a binder of an organic compound (silicon resin, epoxy resin, acrylic resin, polyurethane resin, or the like) to form the antistatic layer 51c.

### Third Embodiment

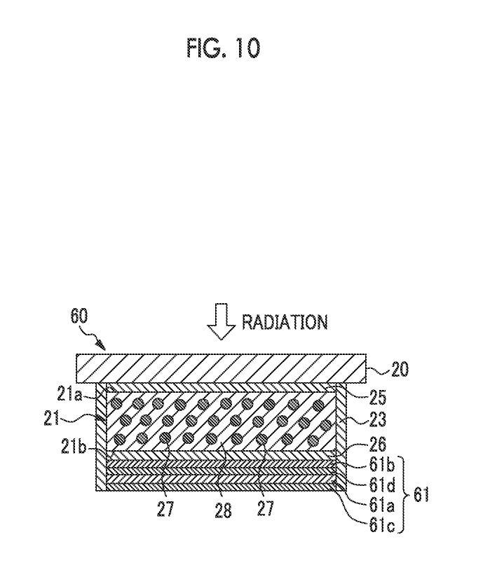

As a third embodiment, a radiographic image detection device 60 shown in FIG. 10 is used. The wavelength conversion layer 21 is supported by a support 61 through the adhesive layer 26. The configuration other than the support 61 is the same as in the first embodiment

The support 61 is constituted by a resin film 61a, a light reflection layer 61b, a first antistatic layer 61c, and a second antistatic layer 61d. The light reflection layer 61b, the second antistatic layer 61d, the resin film 61a, and the first antistatic layer 61c are laminated in this order from the incidence side of radiation incident from the radiation source 11 during imaging. The resin film 61a is formed of resin, such as PET having no antistatic property. The light reflection layer 61b is bonded to the wavelength conversion layer 21 through the adhesive layer 26.

The first antistatic layer 61c is a layer which is formed by coating or depositing an antistatic material or a conductive material on the surface of the resin film 61a opposite to the wavelength conversion layer 21. The second antistatic layer 61d is a layer which is formed by coating or depositing an antistatic material or a conductive material on the surface of the resin film 61a facing the wavelength conversion layer 21. The light reflection layer 61b is formed on the second antistatic layer 61d.

The first antistatic layer 61c is formed of a conductive material primarily containing atoms having an atomic number greater than 31 and having high radiation shield capability. Examples of the atoms include lead (Pb), tungsten (W), tantalum (Ta), and the like. The second antistatic layer 61d is formed of the same material (a conductive material (for example, copper (Cu)) primarily containing one atom having an atomic number of 20 to 31, or a conductive material primarily containing two or more atoms having an atomic number of 20 to 31) as the antistatic layer 51c of the second embodiment. These conductive materials are in a powdered state and are dispersed in a binder of an organic compound (silicon resin, epoxy resin, acrylic resin, polyurethane resin, or the like).

In the second antistatic layer 61d, while backscattering is small and backscattering prevention capability is high, shield capability of a high energy component of radiation is low. In the first antistatic layer 61c, while backscattering is comparatively large and backscattering prevention capability is low, shield capability of a high energy component of radiation is excellent. For this reason, radiation which is incident on the radiographic image detection device 60 and is transmitted through the wavelength conversion layer 21 during imaging is incident on the second antistatic layer 61d, and while backscattering in the second antistatic layer 61d is small, a high energy component of radiation is transmitted through the second antistatic layer 61d and is incident on the first antistatic layer 61c. The first antistatic layer 61c shields incident radiation, but generates backscattered rays. The backscattering rays have low energy (primarily, characteristic X-rays), and are thus shielded by the second antistatic layer 61d.

Accordingly, with the first and second antistatic layers 61c and 61d, backscattering to the wavelength conversion layer 21 is small, light re-emission (unintended light emission) in the wavelength conversion layer 21 is prevented, and radiation toward the control processing device 13 is shielded, whereby damage to the control processing device 13 by radiation is suppressed.

In this way, the antistatic layers are provided on both surfaces of the resin film 61a, whereby an antistatic property and heat dissipation are further improved, in addition to backscattering prevention capability and radiation shield capability.

The second antistatic layer 61d is arranged closer to (preferably, to be in contact with) the wavelength conversion layer 21, whereby it is possible to prevent backscattered rays from the first antistatic layer 61c or the control processing device 13 from being incident on the wavelength conversion layer 21 through the outside of the second antistatic layer 61d.

If the first antistatic layer 61c is produced only by a conductive material primarily containing atoms having a large atomic number, the weight of the support 61 is large. For this reason, for reduction in weight, the first antistatic layer 61c may be formed by mixing atoms having a large atomic number and atoms having a small atomic number.

### Fourth Embodiment

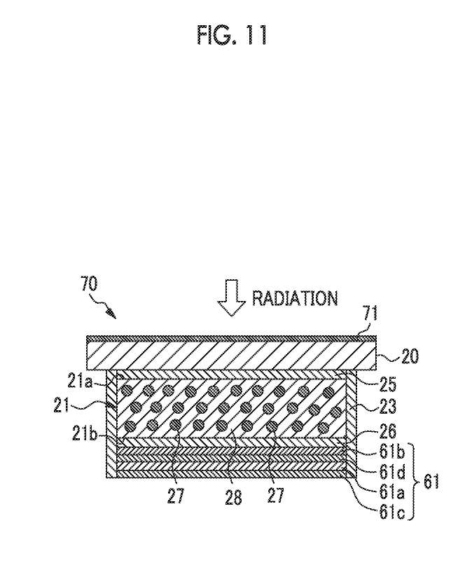

Next, a fourth embodiment will be described In FIG. 11, a radiographic image detection device 70 of the fourth embodiment is provided with a third antistatic layer 71 on the radiation incidence-side surface of the solid-state detector 20, in addition to the configuration of the third embodiment. The third antistatic layer 71 is formed of the same material as the antistatic layer 51c of the second embodiment. It is preferable that the third antistatic layer 71 is formed to be as thin as possible and to have a uniform thickness since radiation incident on the wavelength conversion layer 21 passes therethrough.

In this way, the third antistatic layer 71 is provided, thereby preventing the solid-state detector 20 from being electrostatically charged. Usually, the solid-state detector 20 is formed using an alkali-free glass substrate, but may be formed using a resin substrate having heat resistance. Since a resin substrate is likely to be electrostatically charged, when the solid-state detector 20 is formed using a resin substrate, this embodiment is preferably applied.

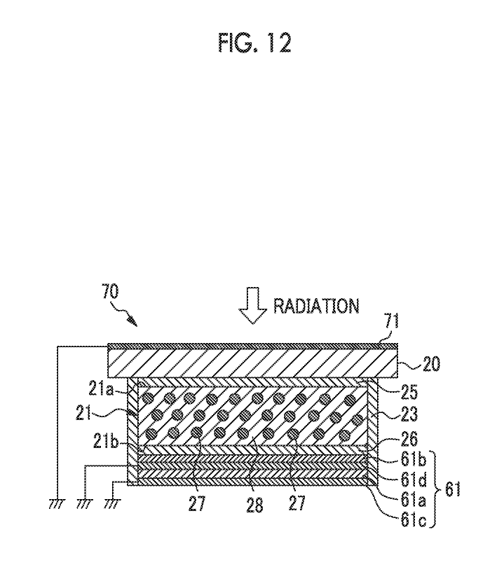

In this embodiment, a potential difference may be generated between the first and second antistatic layers 61c and 61d provided in the support 61 and the third antistatic layer 71 provided in the solid-state detector 20, whereby an electric field may be generated. For this reason, as shown in FIG. 12, it is preferable that all the first to third antistatic layers 61c, 61d, and 71 are connected to the ground potential and are at the same potential.

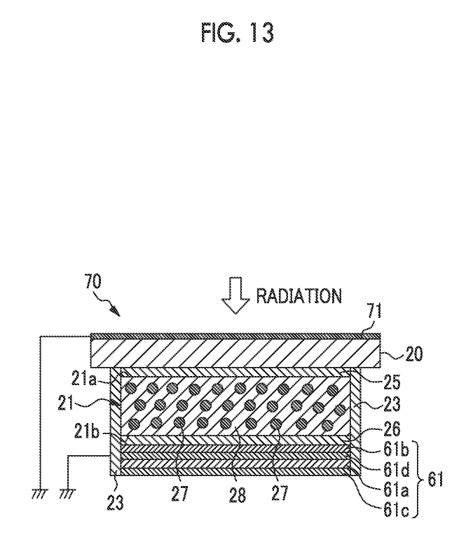

When the edge pasting member 23 is conductive, as shown in FIG. 13, the first and second antistatic layers 61c and 61d may be connected to the ground potential through the edge pasting member 23. Since the edge pasting member 23 is connected to the first and second antistatic layers 61c and 61d, the first to third antistatic layers 61c, 61d, and 71 are at the same potential.

In a process for manufacturing the radiographic image detection device 60, it is preferable that, when bonding the solid-state detector 20 to the wavelength conversion layer 21, the first to third antistatic layers 61c, 61d, and 71 are at the same potential.

As in the first and second embodiments, it is needless to say that an antistatic layer may be provided on the surface of the solid-state detector 20. In this case, it is preferable that the respective antistatic layers are at the same potential.

### Fifth Embodiment

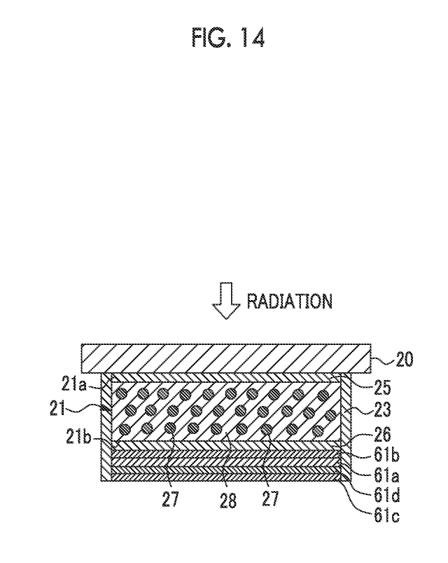

In the third embodiment, although the resin film 61a and the first and second antistatic layers 61c and 61d are arranged in an order of the second antistatic layer 61d, the resin film 61a, and the first antistatic layer 61c from the incidence side of radiation, in a fifth embodiment, as shown in FIG. 14, the resin film 61a, the second antistatic layer 61d, the first antistatic layer 61c are arranged in this order from the incidence side of radiation. Other configurations, such as the material of the first and second antistatic layers 61c and 61d, are the same as those in the third embodiment.

In the third embodiment, since the resin film 61a is sandwiched between the first and second antistatic layers 61c and 61d and thus has a capacitor structure, an electric charge is likely to be accumulated (likely to be electrostatically charged), and may have an influence on an image generated by the solid-state detector 20. Meanwhile, in this embodiment, since the first and second antistatic layers 61c and 61d are in contact with each other, an electrostatic property is low, and it is possible to suppress the influence on the solid-state detector 20.

In this embodiment, it is preferable that the third antistatic layer is provided on the surface of the solid-state detector 20 or the respective antistatic layers are connected to the ground potential. The first and second antistatic layers 61c and 61d may be connected to the ground potential through the edge pasting member 23.

In the above-described embodiments, although the wavelength conversion layer is bonded to the support through the adhesive layer, the wavelength conversion layer and the support may be directly bonded together by heat compression.

In the above-described embodiments, although the wavelength conversion layer is bonded to the solid-state detector through the adhesive layer, the wavelength conversion layer may be pressed to be in direct contact with the solid-state detector.

What is claimed is:

1. A radiographic image detection device comprising:
a wavelength conversion layer which converts radiation to light,
a support which supports the wavelength conversion layer; and
a solid-state detector which detects light to generate image data,
wherein the solid-state detector, the wavelength conversion layer, and the support are arranged in an order of the solid-state detector, the wavelength conversion layer, and the support from the incidence side of radiation during imaging, and
the support has an antistatic property.

2. The radiographic image detection device according to claim 1,
wherein the support has an antistatic resin film.

3. The radiographic image detection device according to claim 2,
wherein the surface specific resistance value of the antistatic resin film is equal to or greater than 10⁶Ω and equal to or smaller than 10⁹Ω.

4. The radiographic image detection device according to claim 1,
wherein the support has a resin film and an antistatic layer formed on the side of the resin film opposite to the wavelength conversion layer.

5. The radiographic image detection device according to claim 4,
wherein the antistatic layer is formed of a conductive material containing atoms having an atomic number of 20 to 31.

6. The radiographic image detection device according to claim 5,
wherein the antistatic layer is formed of a conductive material containing one or two or more of atoms having an atomic number of 24, 26, 28, 29, and 30.

7. The radiographic image detection device according to claim 1,
wherein the support has a resin film, a first antistatic layer formed on the side of the resin film opposite to the wavelength conversion layer, and a second antistatic layer formed on the side of the resin film facing the wavelength conversion layer.

8. The radiographic image detection device according to claim 1,
wherein the support has a resin film and first and second antistatic layers formed on the side of the resin film opposite to the wavelength conversion layer, and the first and second antistatic layers are arranged in an order of the second antistatic layer and the first antistatic layer from the resin film side.

9. The radiographic image detection device according to claim 7,
wherein the first antistatic layer is formed of a conductive material containing atoms having an atomic number greater than 31, and the second antistatic layer is formed of a conductive material containing atoms having an atomic number of 20 to 31.

10. The radiographic image detection device according to claim 8,
wherein the first antistatic layer is formed of a conductive material containing atoms having an atomic number greater than 31, and the second antistatic layer is formed of a conductive material containing atoms having an atomic number of 20 to 31.

11. The radiographic image detection device according to claim 9,
wherein the second antistatic layer is formed of a conductive material containing one or two or more of atoms having an atomic number of 24, 26, 28, 29, and 30.

12. The radiographic image detection device according to claim 9,
wherein the composite elasticity of the wavelength conversion layer and the support is lower than the elasticity of the solid-state detector.

13. The radiographic image detection device according to claim 12,
wherein each conductive material is in a powdered state and dispersed in a binder.

14. The radiographic image detection device according to claim 7, further comprising:
a third antistatic layer on the side of the solid-state detector opposite to the wavelength conversion layer.

15. The radiographic image detection device according to claim 14,
wherein the first antistatic layer, the second antistatic layer, and the third antistatic layer are connected to a ground potential.

16. The radiographic image detection device according to claim 15, further comprising:
an edge pasting member having an antistatic property to cover the lateral surface of the peripheral edge of the wavelength conversion layer.

17. The radiographic image detection device according to claim 16,
wherein the first antistatic layer and the second antistatic layer are connected to the ground potential through the edge pasting member.

18. The radiographic image detection device according to claim 1,
wherein the wavelength conversion layer is formed by dispersing phosphor particles in a binder.

19. The radiographic image detection device according to claim 18,
wherein the phosphor particles are formed of A₂O₂S:X, A is one of Y, La, Gd, and Lu, and X is one of Eu, Tb, and Pr.

20. The radiographic image detection device according to claim 1,
wherein the support has a light reflection layer which reflects light generated by the wavelength conversion layer, and the light reflection layer is bonded to the wavelength conversion layer.
